(19) United States
(12) Patent Application Publication
(10) Pub. No.: US 2010/0108927 A1
(43) Pub. Date: May 6, 2010

(54) SILENT SOLENOID VALVE FOR FLUID REGULATION SYSTEM

(75) Inventors: Daniel J. Perz, Windsor (CA); Jeffrey Scheuher, Livonia, MI (US)

Correspondence Address: HOWARD & HOWARD ATTORNEYS PLLC, 450 West Fourth Street, Royal Oak, MI, 48067, US

(73) Assignee: MAXITROL COMPANY, Southfield, MI (US)

(21) Appl. No.: 12/614,110

(22) Filed: Nov. 6, 2009

Related U.S. Application Data
(60) Provisional application No. 61/111,777, filed on Nov. 6, 2008.

(51) Int. Cl. F16K 31/02

(52) U.S. Cl. 251/129.15

(57) ABSTRACT

A fluid regulator system includes at least one solenoid valve for interrupting flow of the fluid. The solenoid valve solenoid valve includes a plunger that is actuated by a solenoid, i.e., a coil. A plunger stop limits movement of the plunger when the solenoid is energized. A recess defined a top of the plunger. A plunger bumper assembly is disposed at least partially within the recess of the top of the plunger and at least partially between the top of the plunger and the plunger stop. The plunger bumper assembly includes a resilient component formed of a resilient material for dampening noise produced by a contact between the plunger bumper assembly and the plunger stop.

### CROSS REFERENCE TO RELATED APPLICATION

This application claims the benefit of provisional patent application No. 61/111,777, filed Nov. 6, 2008, which is hereby incorporated by reference.

### BACKGROUND OF THE INVENTION

1. Field of the Invention

The present invention relates generally to fluid regulators, and more specifically to gas regulators having solenoid valves.

2. Description of the Related Art

Gas regulators, including those having one and two-solenoid valve configurations (e.g., being connected in series fluid communication), have been used in various gas-fired appliances (e.g., gas fireplaces, space heaters, ovens, furnaces, water heaters, agricultural heaters, and so forth) for several years. These gas valves are typically operated electrically, and are generally incorporated into a regulator system that controls the flow of gas into the particular appliance.

Typically, as shown in FIG. 1, these gas valves employ a plunger P housed in a solenoid sleeve S. A terminal portion of the plunger P is provided with a plunger eyelet E that is at least partially disposed in a generally circular recess R formed on the tip portion of the plunger P, with a portion of the plunger eyelet E extending out from the recess R and forming a substantially circular rounded exterior lip portion L. The plunger eyelet E is typically comprised of a metallic material, such as but not limited to brass. When the solenoid is energized (e.g., through the application of electrical energy to the solenoid), the plunger P is forced towards a plunger stop PS such that the lip portion L of the plunger eyelet E strikes the plunger stop PS, simultaneously lifting a valve member off of its valve seat, and thus allowing gas to flow through the regulator and eventually through to the appliance. The plunger stop PS is typically also comprised of metal, such as but not limited to steel. Unfortunately, the striking of these two metallic surfaces against one another typically generates a “clicking” noise that most consumers find undesirable.

Accordingly, there exists a need for new and improved solenoid gas valves for use with various types of gas-fired appliances that overcome at least one of the aforementioned problems.

### SUMMARY OF THE INVENTION

The present invention discloses a fluid regulator system. The system includes a housing. The housing defines an inlet for receiving a fluid, a passage in fluid communication with the inlet for accommodating the fluid, and an outlet in fluid communication with the passage for discharging the fluid. The system also includes a regulator for regulating flow of the fluid through the passage. At least one solenoid valve interrupts the flow of the fluid through the passage. The at least one solenoid valve includes a valve member disposed inline with the passage and movable between an open position and a closed position. A plunger having a top, a bottom, and a side wall extends between the top and the bottom. The bottom is operatively connected to the valve member for moving the valve member between the positions. A recess is defined in the top of the plunger. A solenoid is disposed around at least a portion of the plunger for actuating the plunger. A plunger stop is disposed adjacent the top of the plunger for stopping movement of the plunger when the valve member is in the open position. A plunger bumper assembly is disposed at least partially within the recess of the top of the plunger and at least partially between the top of the plunger and the plunger stop. The plunger bumper assembly includes a resilient component formed of a resilient material for dampening noise produced by a contact between the plunger bumper assembly and the plunger stop.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a partial cross-sectional view of a prior art solenoid valve plunger;

FIG. 2 is a partial cross-sectional view a fluid regulating system of the subject invention with valve members in a closed position;

FIG. 3 is a partial cross-sectional view the fluid regulating system of the subject invention with the valve members in an open position;

FIG. 4 is a partial cross-sectional view of a first embodiment of a plunger of a solenoid valve detailing a plunger bumper assembly;

FIG. 5 is a perspective view of the first embodiment of the plunger;

FIG. 6 is a partial cross-sectional view of a second embodiment of the plunger of the solenoid valve detailing the plunger bumper assembly; and

FIG. 7 is a perspective view of the second embodiment of the plunger.

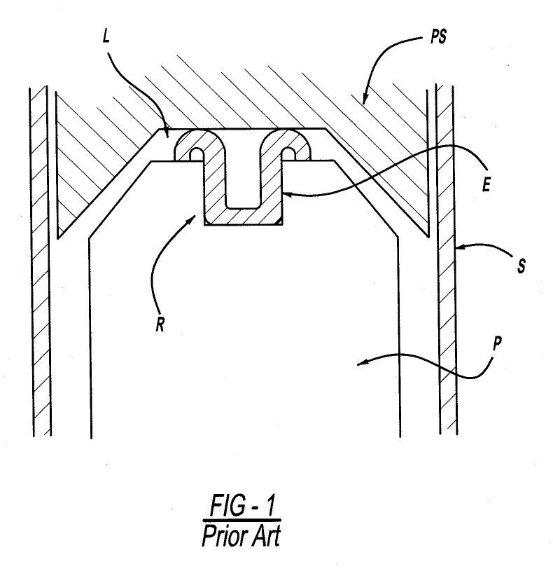

### DETAILED DESCRIPTION OF THE INVENTION

Referring to the Figures, wherein like numerals indicate like parts throughout the several views, a fluid regulator system 1 is shown herein. In the illustrated embodiments, the fluid is a gas, such as a combustible gas. However, those skilled in the art realize the other gases or fluids may be implemented within the scope of the described invention.

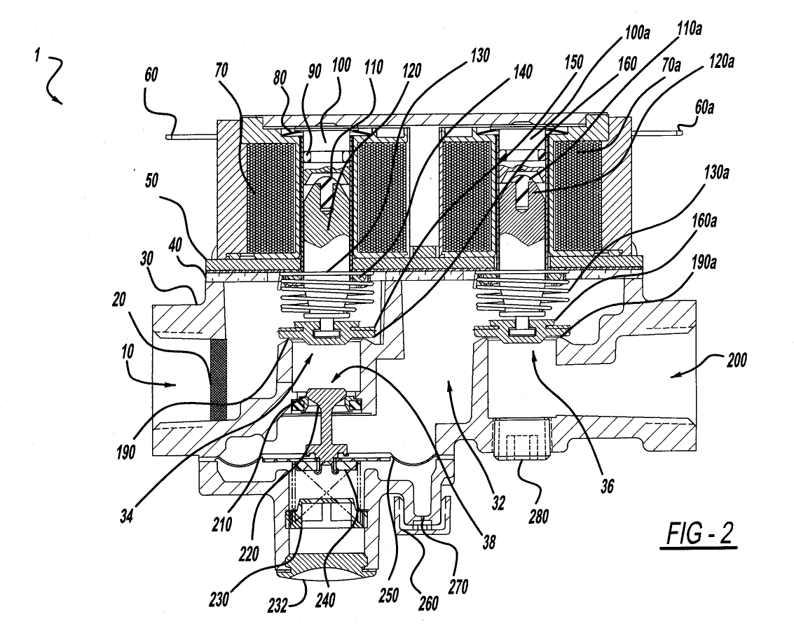

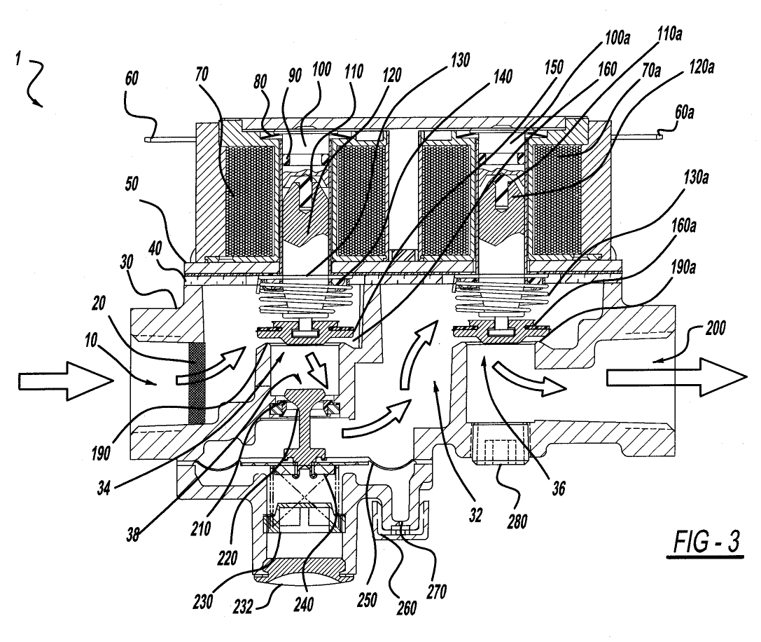

With reference to FIGS. 2 and 3, the system 1 includes a body housing 30. The housing 30 defines an inlet 10 for receiving a fluid and an outlet 200 for discharging the fluid. An inlet screen 20 is disposed within the inlet 10 for filtering the fluid. The housing 30 also defines a passage 32 fluidically connecting the inlet 10 to the outlet 200. The housing 30 may be formed of a cast metal; however, those skilled in the art realize other techniques and materials used to form the housing 30.

The system 1 includes an inlet valve 34 and an outlet valve 36 each disposed to interrupt flow of the fluid through the passage 32. Specifically, the inlet valve 34 interrupts flow of the fluid adjacent the inlet 10 while the outlet valve 36 interrupts flow of the fluid adjacent the outlet 200. However, those skilled in the art realize that a single valve could be implemented instead of the pair of valves 34, 36.

The system 1 also includes a regulator 38 to regulate flow of the fluid through the passage 32. Specifically, the regulator 38 is fluidically disposed between the inlet and outlet valves 34, 36. The regulator 38 includes a regulator valve seat 210 cooperating with a regulator valve member 220. An adjusting screw 230 operates to move the regulator valve member 220, and thus regulate the flow of the fluid. A spring 240 is connected to both the adjusting screw 230 and the regulator valve member 220. A seal cap 232 protects the adjusting screw 230. The regulator 38 also includes a diaphragm 250, a dust cap 260, and a vent limiting orifice 270.

The inlet valve 34 includes an inlet valve member 160 and the outlet valve 36 includes an outlet valve member 160a. Each valve member 160, 160a is disposed inline with the passage 32. The valve members 160, 160a are movable between an open position, in which fluid may flow through the passage 32 adjacent the member 160, 160a, and a closed position, in which fluid is blocked from flowing through the passage 32 adjacent the 160, 160a. In the illustrated embodiments, the valve members 160, 160a are each disc shaped and include a valve insert 150. Also in the illustrated embodiments, the housing 30 defines an inlet valve seat 190 and an outlet valve seat 190a for interfacing with the respective valve members 160, 160a. However, those skilled in the art appreciate other techniques for opening and closing the passage 32, besides the disc-shaped valve members 160, 160a and seats 190, 190a shown herein.

The valves 34, 36 of the illustrated embodiment are solenoid valves. That is, each valve 34, 36 utilizes a solenoid 70, 70a, also commonly referred to as a coil, to actuate the valve members 160, 160a between open and closed positions. The valves 34, 36 each include an electrical connector 60, 60a electrically connected to the solenoids 70, 70a for supplying electric current to the solenoids 70, 70a. The solenoids 70, 70a of the illustrated embodiment are supported by a frame 50. A gasket 40 is sandwiched between the frame 50 and the housing 30.

Each valve 34, 36 includes a plunger 120, 120a disposed within the solenoid 70, 70a and operatively connected to the valve member 160, 160a. The plunger 120, 120a is preferably formed of a magnetic member, such that movement of the plunger 120, 120a occurs when the solenoid 70, 70a is energized, i.e., when electric current is applied to the solenoid 70, 70a.

FIG. 2 shows the fluid regulator system 1 with the valves 34, 36 in the closed position, in that fluid is not able to flow through the system 1. More specifically, the inlet valve member 160 is pressed relatively tightly against the inlet valve seat 190, and the outlet valve member 160a is pressed relatively tightly against the outlet valve seat 190a. The force to keep the inlet solenoid valve 160 and the outlet solenoid valve 160a pressed relatively tightly against the inlet valve seat 190 and the outlet valve seat 190a, respectively, is supplied by an inlet plunger spring 130 and an outlet plunger spring 130a, respectively. Thus, by way of a non-limiting example, when the respective solenoids 70 and 70a are not energized, the inlet plunger spring 130 and outlet plunger spring 130a provide a sufficient spring force to keep the fluid regulator system 1 from allowing any gas flow therethrough. It should also be noted that only one of either the inlet valve member 160 or the outlet valve member 160a needs to be in contact against their respective valve seat, i.e., inlet valve seat 190 or outlet valve seat 190a, in order to prevent fluid flow through the entirety of the fluid regulator system 1.

Referring now to FIG. 3, when it is desired to allow the fluid to flow through the system 1, it is necessary to cause at least one, and preferably both of the inlet valve member 160 and the outlet valve member 160a to be lifted off of their respective valve seats, i.e., the inlet valve seat 190 and the outlet valve seat 190a. Typically, this is accomplished by energizing (e.g., by the application of an electric current) one or both of the respective solenoids 70, 70a, which are coupled, either directly or indirectly, to their respective valves members, i.e., the inlet valve member 160 and the outlet valve member 160a. It should be noted that the respective solenoids 70, 70a can be energized simultaneously or in sequence (e.g., the inlet solenoid 70a can be energized first and then the outlet solenoid 70a can be energized thereafter, or if desired for whatever reason, the outlet solenoid 70a can be energized first and then the inlet solenoid 70 can be energized thereafter).

When the respective solenoids 70, 70a are energized, the respective inlet plunger 120 and outlet plunger 120a are forced (in this case, upwardly, overcoming the spring force of inlet plunger spring 130 and outlet plunger spring 130a, respectively) towards their respective plunger stop 100, 100a. Specifically, the inlet valve 34 includes an inlet plunger stop 100 and the outlet valve 36 includes an outlet plunger stop 100a. In this manner, fluid flow through the system can be achieved. The fluid flow is shown by the series of arrows.

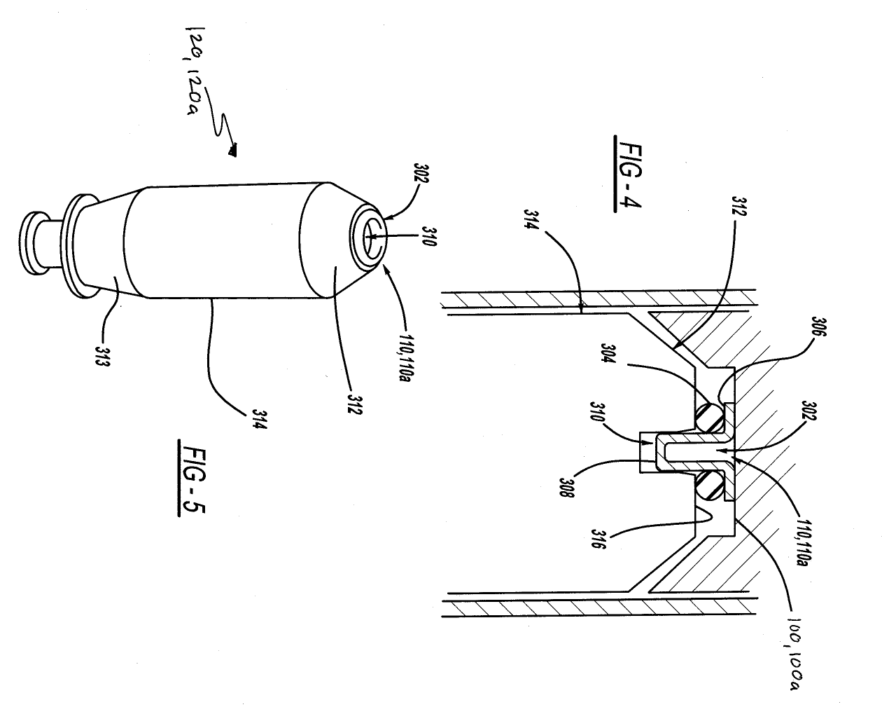

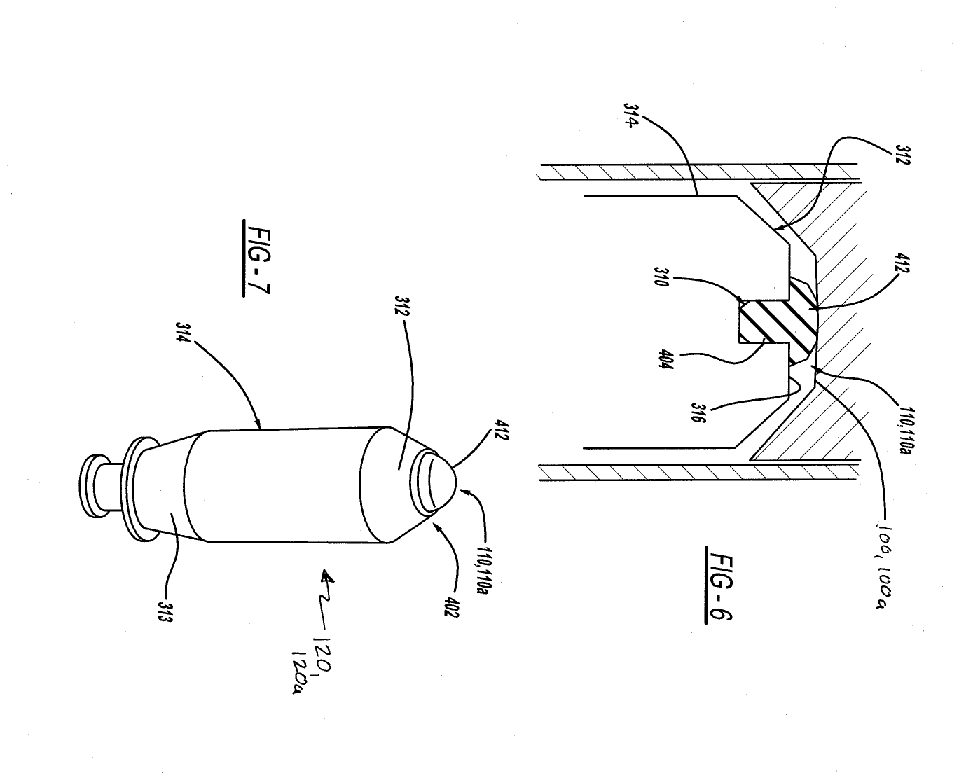

FIGS. 4 and 5 show a first embodiment of the plungers 120, 120a while FIGS. 6 and 7 show a second embodiment of the plungers 120, 120a. Each plunger 120, 120a includes a top 312, a bottom 313, and a side wall 314 extending between the top 312 and the bottom 313. In these illustrated embodiments, the side wall 314 has a cylindrical shape. The top 312 and bottom 313 each have a frustoconical shape, as can be seen in FIGS. 7 and 9. That is, the top 312 and bottom 313 each have an angled portion (not numbered) extending inward away from the side wall 314 and a flat portion 316, wherein a diameter of the flat portion 316 is less than a diameter across the side wall 314.

The bottom 313 of each plunger 120, 120a is connected to the respective valve member 160, 160a, as can be seen in FIGS. 2 and 3. The plunger springs 130, 130a are also preferably connected to the bottom 313 of each respective plunger 120, 120a.

A recess 310 is defined by the top 312 of each plunger 120, 120a. More specifically, the recess 310 is a cylindrical hole extending downward from the flat portion 316 of the top 312. Each valve 32, 34 also includes a plunger bumper assembly 110, 110a. Each assembly 300 is disposed at least partially within the recess 310. Specifically, each assembly 300 is connected to the plunger 120, 120a within the recess 310.

Each assembly 300 includes a resilient component (not separately numbered) for dampening noise produced by the contact caused by the energization of the solenoid 70, 70a. Specifically, the resilient component dampens noise caused by the contact between each plunger 120, 120a and each plunger stop 100, 100a, when the valve member 160, 160a is moved to the open position.

In the first embodiment, as shown in FIGS. 4 and 5, the plunger bumper assembly 300 includes a plunger recess part 302. The plunger recess part 302 includes a base portion 308 and a lip portion 306. The base portion 308 is disposed at least partially within the recess 310. As such, the base portion 308 has a cylindrical shape to cooperate with the cylindrical shape of the recess 310. The lip portion 306 extends generally perpendicularly away from the base portion 308 to define a ring shape. The lip portion 306 is separated from, i.e., does not make direct contact with, the top 312 of the plunger 120, 120a. The plunger recess part 302 is preferably formed of a metal, however, other materials, such as plastics, may be used, as is known to those skilled in the art. Regardless of the particular material chosen, the plunger recess part 302 should be durable, rigid, and if possible, non-magnetic. Said another way, the plunger recess part 302 may be non-resilient.

The resilient component of the plunger bumper assembly 300 of the first embodiment is an o-ring 304. The o-ring 304 is disposed between the lip portion 306 and the top 312 of the plunger 120, 120a. The o-ring 304 is preferably formed of a resilient material such as rubber. However, foams, relatively soft and flexible plastics, and/or the like, and other materials may also be utilized for the o-ring 304. Regardless of the particular material chosen, the o-ring 304 should be durable, resilient, and if possible, non-magnetic. Thus, in this first embodiment, when the lip portion 306 of strikes the plunger stop 318, the o-ring 304 cushions the impact of the two surfaces, thus reducing the resulting sound of the impact.

In the second embodiment, as shown in FIGS. 6 and 7, the resilient component of the plunger bumper assembly 110, 110a includes a base portion 404 and a head portion 412. The base portion 404 is disposed within the recess 310 of the plunger. The resilient component of the plunger bumper assembly 300 of the second embodiment is at least the head portion 412. That is, the head portion 412 is formed of rubber, foam, plastic, or other durable, resilient materials. The head portion 412 has generally circular shaped or mushroom shaped. The base portion 404 may also be considered part of the resilient component. That is, the base portion 404 may also be formed of rubber, foam, plastic, etc. Specifically, the base portion 404 and the head portion 412 are integrally formed of a common material. That is, the base portion 404 and the head portion 412 have one-piece construction. However, those skilled in the art realize that the base portion 404 and head portion 412 may formed of different materials and simply attached together by known means.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A fluid regulator system comprising:
a housing defining an inlet for receiving a fluid, a passage in fluid communication with said inlet for accommodating the fluid, and an outlet in fluid communication with said passage for discharging the fluid;
a regulator for regulating flow of the fluid through said passage; and
at least one solenoid valve for interrupting the flow of the fluid through said passage, said at least one solenoid valve including
a valve member disposed inline with said passage and movable between an open position and a closed position,
a plunger having a top, a bottom, and a side wall extending between said top and said bottom, wherein said bottom is operatively connected to said valve member for moving said valve member between said positions,
said top of said plunger defining a recess therein,
a solenoid disposed around at least a portion of said plunger for actuating said plunger,
a plunger stop disposed adjacent said top of said plunger for stopping movement of said plunger when said valve member is in said open position, and
a plunger bumper assembly disposed at least partially within said recess of said top of said plunger and at least partially between said top of said plunger and said plunger stop, and wherein
said plunger bumper assembly includes a resilient component formed of a resilient material for dampening noise produced by a contact between said plunger bumper assembly and said plunger stop.

2. A system as set forth in claim 1 wherein said plunger bumper assembly includes a plunger recess part having a base portion at least partially disposed within said plunger recess and a lip portion extending away from said base portion.

3. A system as set forth in claim 2 wherein said resilient component is further defined as an o-ring disposed between said lip portion of said plunger recess part said top of said plunger.

4. A system as set forth in claim 3 wherein said o-ring is formed of rubber.

5. A system as set forth in claim 2 wherein said plunger recess member is formed of a non-resilient material.

6. A system as set forth in claim 2 wherein said plunger recess part is formed of a metal.

7. A system as set forth in claim 1 wherein said resilient component is further defined as a base portion disposed within said recess of said plunger and a head portion connected to said base portion and disposed between said top of said plunger and said plunger stop.

8. A system as set forth in claim 7 wherein said head portion and said base portion are integrally formed.

9. A system as set forth in claim 8 wherein said head portion and said base portion are formed of rubber.

10. A system as set forth in claim 7 wherein said plunger bumper assembly consists of said resilient component.

11. A system as set forth in claim 1 wherein said side wall of said plunger has a cylindrical shape.

12. A system as set forth in claim 11 wherein said top of said plunger has a frustoconical shape.

13. A system as set forth in claim 1 wherein said valve member of said at least one solenoid valve has a disc shape.

14. A system as set forth in claim 13 wherein said base defines at least one valve seat for interfacing with said disc-shaped valve member of said at least one solenoid valve.

15. A system as set forth in claim 1 wherein said at least one solenoid valve is further defined as an inlet valve disposed in proximity to said inlet and an outlet valve disposed in proximity to said outlet.

16. A solenoid valve for interrupting the flow of a fluid therethrough, said at valve comprising:
a valve member movable between an open position and a closed position;
a plunger having a top, a bottom, and a side wall extending between said top and said bottom, wherein said bottom is operatively connected to said valve member for moving said valve member between said positions;
said top of said plunger defining a recess therein;
a solenoid disposed around at least a portion of said plunger for actuating said plunger;
a plunger stop disposed adjacent said top of said plunger for stopping movement of said plunger when said valve member is in said open position; and
a plunger bumper assembly disposed at least partially within said recess of said top of said plunger and at least partially between said top of said plunger and said plunger stop; and wherein
said plunger bumper assembly includes a resilient component formed of a resilient material for dampening noise produced by a contact between said plunger bumper assembly and said plunger stop.
